(19) United States
(12) Patent Application Publication
(10) Pub. No.: US 2025/0308138 A1
(43) Pub. Date: Oct. 2, 2025

(54) METHOD AND SYSTEM FOR IMPLEMENTING RADIANCE FIELD USING ADAPTIVE MAPPING FUNCTION

(71) Applicant: GWANGJU INSTITUTE OF SCIENCE AND TECHNOLOGY, Gwangju (KR)

(72) Inventors: Hae Gon JEON, Gwangju (KR); Jun Oh LEE, Gwangju (KR); Hyun Jun JUNG, Gwangju (KR); Jin Hwi PARK, Gwangju (KR); In Hwan BAE, Gwangju (KR)

(73) Assignee: GWANGJU INSTITUTE OF SCIENCE AND TECHNOLOGY, Gwangju (KR)

(21) Appl. No.: 19/002,445

(22) Filed: Dec. 26, 2024

(30) Foreign Application Priority Data
Apr. 1, 2024 (KR) 10-2024-0044389

(51) Int. Cl. G06T 15/06; G06T 7/90

(52) U.S. Cl. CPC G06T 15/06; G06T 7/90; G06T 2207/10024

(57) ABSTRACT

A method of implementing a radiance field is provided. The method includes calculating a radiance function in an infinite space on the basis of camera viewpoints for the set of scene images; projecting rays based on the radiance function onto a manifold in a finite space using a predefined mapping function based on a P-Norm distance; calculating a color in the finite space corresponding to the set of scene images on the basis of the projected rays and generating a generated image corresponding to the camera viewpoints on the basis of the calculated color; and implementing a radiance field on the basis of the camera viewpoints and the generated image.

### DESCRIPTION OF GOVERNMENT-SPONSORED RESEARCH

The present invention was carried out with support from the national research and development project, with the unique project identification number being 1415177564 and the project number being P0019797. The project related to the present invention is supervised by the Ministry of Trade, Industry, and Energy, and managed by the Korea Institute for Advancement of Technology (KIAT). The research program is titled “Industrial Technology International Cooperation (R&D) Project,” and the research project is named “Development of a User-Participatory Metaverse Performance Solution Based on Neural Human Modeling.” The project executing institution is WYSIWYG Studios Co., Ltd., and the research period is from Dec. 1, 2021, to Nov. 30, 2024.

In addition, the present invention was carried out with support from the national research and development project, with the unique project identification number being 1711197190 and the project number being 2022-DD-UP-0312-02. The project related to the present invention is supervised by the Ministry of Science and ICT, and managed by (Foundation) the Korea Innovation Foundation (INNOPOLIS). The research project is titled “Regional Research and Development Innovation Support Project,” and the research project is named “Convergent Cultural Virtual Studio for AI-Based Metaverse Implementation.” The project executing institution is Gwangju Institute of Science and Technology, and the research period is from Apr. 1, 2022, to Dec. 31, 2026.

In addition, the present invention was carried out with support from the national research and development project, with the unique project identification number being 1711196775 and the project number being S1602-20-1001. The project related to the present invention is supervised by the Ministry of Science and ICT, and managed by the National IT Industry Promotion Agency (NIPA). The research program is titled “AI-Centered Industrial Convergence Cluster Development (R&D) Project,” and the research project is named “Development of Customized Autonomous Driving Software Platform Technology for Specific-Purpose Vehicles.” The project executing institution is Autonomous a2z Co., Ltd., and the research period is from Apr. 1, 2020, to Dec. 31, 2024.

In addition, the present invention was carried out with support from the national research and development project, with the unique project identification number being 1711139517 and the project number being 2021-0-02068-001. The project related to the present invention is supervised by the Ministry of Science and ICT, and managed by the Institute of Information and Communications Technology Planning and Evaluation (IITP). The research program is titled “ICT Broadcasting Innovation Talent Development (R&D) Project,” and the research project is named “Research and Development of AI Innovation Hub.” The project executing institution is Korea University, and the research period is from Jul. 1, 2021, to Dec. 31, 2025.

In addition, the present invention was carried out with support from the national research and development project, with the unique project identification number being 1711193897 and the project number being 2019-0-01842-005. The project related to the present invention is supervised by the Ministry of Science and ICT, and managed by the Institute of Information and Communications Technology Planning and Evaluation (IITP). The research program is titled “ICT Broadcasting Innovation Talent Development Project,” and the research project is named “Support for AI Graduate Schools (GIST).” The project executing institution is Gwangju Institute of Science and Technology, and the research period is from Sep. 1, 2019, to Dec. 31, 2023.

### CROSS REFERENCE TO RELATED APPLICATION

The present application claims priority to Korean Patent Application No. 10-2024-0044389, filed on Apr. 1, 2024, the entire contents of which is incorporated herein for all purposes by this reference.

### BACKGROUND

### Field

The present invention relates to a method and system for implementing a radiance field using an adaptive mapping function.

### Description of the Related Art

Recently, in the fields of computer vision and graphics, methods of rendering continuous 3D viewpoints of a specific scene have been actively studied. In particular, a method of rendering images from the new perspectives using multiple scene images has been proposed.

Specifically, the neural radiance field (NeRF) may calculate a radiance function on the basis of the position and direction of a camera for multiple scene images, and predict the color of the scene as viewed from the position and direction of a specific camera using a plurality of points on the calculated radiance function.

Accordingly, the neural radiance field (NeRF) may implement a radiance field by training a multi-layer perceptron (MLP) to convert a five-dimensional variable, corresponding to the position and direction of a specific camera, into a four-dimensional variable related to the color of the image on the basis of the previously predicted scene color. Therefore, it is possible to generate the image of a scene as viewed from all camera positions and directions within the radiance field.

### SUMMARY

The present invention relates to a method and system for implementing a radiance field using an adaptive mapping function.

In addition, the present invention relates to a method and system for implementing a radiance field using an adaptive mapping function that adaptively samples camera rays for both scenes with boundaries and scenes without boundaries in a three-dimensional space.

In addition, the present invention relates to a method and system for implementing a radiance field using an adaptive mapping function that accurately estimates images from all camera viewpoints, even for images of boundary-free scenes, including backgrounds.

To solve the aforementioned objects, there is provided a method of implementing a radiance field, according to the present invention. The method may include: receiving a set of scene images; calculating a radiance function in an infinite space on the basis of camera viewpoints for the set of scene images; projecting rays based on the radiance function in the infinite space onto a manifold in a finite space using a predefined mapping function based on a P-Norm distance; calculating a color in the finite space corresponding to the set of scene images on the basis of the projected rays and generating a generated image corresponding to the camera viewpoints on the basis of the calculated color; and implementing a radiance field on the basis of the camera viewpoints and the generated image.

In addition, there is provided a system for implementing a radiance field, according to the present invention. The system may include: an input unit configured to receive a set of scene images; and a control unit configured to implement a radiance field on the basis of the set of scene images, in which the control unit may calculate a radiance function in an infinite space on the basis of camera viewpoints for the set of scene images, project rays based on the radiance function in the infinite space onto a manifold in a finite space using a predefined mapping function based on a P-Norm distance, calculate a color in the finite space corresponding to the set of scene images on the basis of the projected rays, generate a generated image corresponding to the camera viewpoints on the basis of the calculated color, and implement a radiance field on the basis of the camera viewpoints and the generated image.

In addition, there is provided a program stored on a computer-readable recording medium, and executed by one or more processes in an electronic device, according to the present invention. The program may include instructions to allow the program to perform: receiving a set of scene images; calculating a radiance function in an infinite space on the basis of camera viewpoints for the set of scene images; projecting rays based on the radiance function in the infinite space onto a manifold in a finite space using a predefined mapping function based on a P-Norm distance; calculating a color in the finite space corresponding to the set of scene images on the basis of the projected rays and generating a generated image corresponding to the camera viewpoints on the basis of the calculated color; and implementing a radiance field on the basis of the camera viewpoints and the generated image.

According to various embodiments of the present invention, the method and system for implementing a radiance field using an adaptive mapping function can adaptively sample the camera rays for both scenes with boundaries and scenes without boundaries in a three-dimensional space by projecting the camera rays onto the manifold in the finite space through a mapping function defined based on the P-Norm distance.

In addition, according to various embodiments of the present invention, the method and system for implementing a radiance field using an adaptive mapping function can accurately estimate images from all camera viewpoints even for images of boundary-free scenes, including backgrounds, by training the neural radiance field (NeRF) on the basis of the rays of the camera projected onto the manifold in the finite space.

### BRIEF DESCRIPTION OF THE DRAWINGS

FIG. 1 illustrates a system for implementing a radiance field according to the present invention.

FIG. 2, FIG. 3A, and FIG. 3B illustrate an embodiment of a mapping function according to a P-Norm distance.

FIG. 4 is a flowchart illustrating a method of implementing a radiance field according to the present invention.

FIGS. 5A, 5B and 5C illustrate an embodiment of mapping rays from an infinite space to a finite space.

FIGS. 6A, 6B and 6C illustrate an embodiment of sampling points based on a value of p for the P-Norm distance.

FIG. 7 illustrates an embodiment of specifying an optimal value of p for the P-Norm distance.

### DETAILED DESCRIPTION OF EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

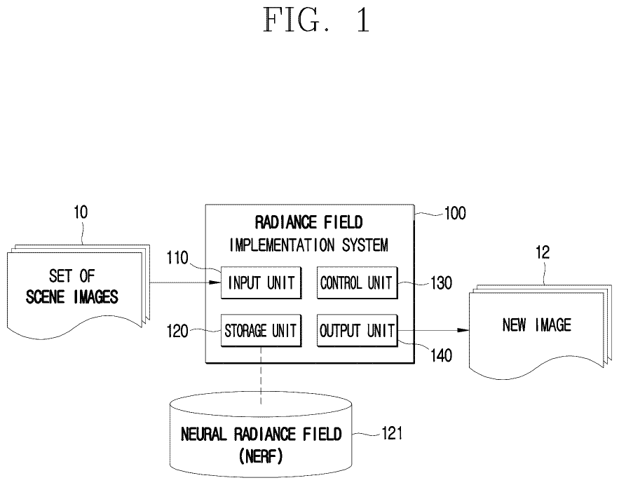

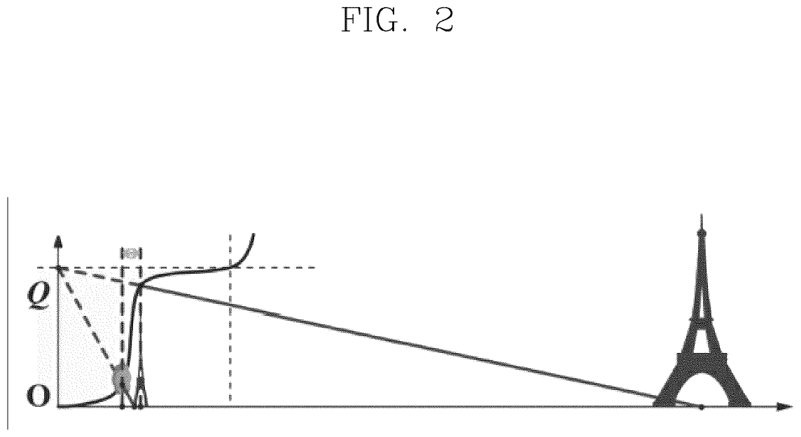

FIG. 1 illustrates a system for implementing a radiance field according to the present invention. FIG. 2, FIG. 3A, and FIG. 3C illustrate an embodiment of a mapping function according to a P-Norm distance.

With reference to FIG. 1, a system 100 for implementing a radiance field according to the present invention may generate a new image corresponding to an arbitrary camera viewpoint by training a neural radiance field (NeRF) using a set of scene images.

Here, the set of scene images may include a plurality of images captured from different camera viewpoints for a specific scene. That is, each of the plurality of images included in the set of scene images may include a camera viewpoint corresponding to each image.

In this case, the camera viewpoint is defined as the position and direction of a camera that captured each image, and may include the position of the camera (e.g., three-dimensional coordinates) as well as the direction in which each image was captured from the position of the corresponding camera (e.g., two-dimensional angles).

In addition, the neural radiance field (NeRF) is a neural network model based on a multi-layer perceptron (MLP), trained using a set of scene images for a specific scene. When an arbitrary camera viewpoint is provided as input for the specific scene, the neural radiance field (NeRF) that has been trained may be trained to output a new image corresponding to the input camera viewpoint.

To this end, the system 100 for implementing a radiance field may calculate a radiance function in an infinite space on the basis of the camera viewpoints for the set of scene images. Using a predefined mapping function based on a P-Norm distance, the system may project rays from the infinite space into a finite space, and then calculate the color (and density) at each camera viewpoint on the basis of the projected rays, and generate a generated image corresponding to each camera viewpoint on the basis of the calculated color (and density).

Here, the infinite space may refer to a space through which rays capturing images from each camera viewpoint proceed.

In this case, the rays may be represented through a radiance function defined based on the camera viewpoint, and such a radiance function may be defined in the form of a linear equation with respect to a ray distance.

Therefore, the ray may appear in a straight-line form, and a space in which the rays in a straight-line form are disposed may be defined as the infinite space.

Meanwhile, the finite space may be a space formed by a given manifold, and this finite space may be a space in which a manifold with a central point of projection is formed. In this case, the central point of the projection may be calculated on the basis of the positions of a plurality of cameras corresponding to the set of scene images.

Specifically, the finite space may be defined to project the ray, which appears in a straight-line form in the infinite space, onto the manifold, thereby converting the ray in a straight-line form into a ray in a curved form.

Therefore, the mapping function may be defined to project the radiance function representing rays in the infinite space onto the manifold in the finite space. Such a mapping function may be defined to convert the ray in a straight-line form in the infinite space into a ray in a curved form in the finite space, on the basis of the P-Norm distance between an arbitrary point based on the radiance function in the infinite space and the central point of the projection (or manifold in the finite space).

Specifically, the mapping function may be defined to adaptively map the infinite space and finite space according to the P-Norm distance for both the distant region and near region represented by the set of scene images.

That is, the mapping function may be defined such that as a value of p in the P-Norm increases, a surface of the manifold provided in the finite space becomes more convex, thereby expressing with emphasis the near region represented by the image. Conversely, as the value of p decreases, the surface of the manifold becomes more concave, thereby expressing with emphasis the distant region represented by the image.

With reference to FIG. 2, in an embodiment, the system 100 for implementing a radiance field may reduce an amount of expression allocated to a free space between the tree and the tower through an adaptive mapping function defined based on the P-Norm distance.

To this end, the system 100 for implementing a radiance field may determine the value of p on the basis of the geometric structure of the scene, and in an embodiment, may automatically set the value of p using a RANSAC framework.

In this regard, with reference to FIG. 3A and FIG. 3B, various embodiments can be seen in which points based on the radiance function are mapped to different positions on the finite space through mapping functions with different values of p being set.

Therefore, the system 100 for implementing a radiance field may calculate the color as seen from each camera viewpoint for each pixel of each image on the basis of the rays mapped to be projected onto the finite space, and generate a generated image according to the calculated colors.

In this case, the generated image is the generation of the scene observed through the radiance field for the set of scene images, and may involve mapping the rays of the camera from the infinite space to the finite space and converting the set of scene images on the basis of the rays of the camera within the finite space.

With reference back to FIG. 1, the system 100 for implementing a radiance field may train the neural radiance field (NeRF) on the basis of the previously generated generated image and the viewpoint of each camera. The system may use the neural radiance field (NeRF) that has been trained to generate a new image corresponding to an arbitrary camera viewpoint.

To this end, the system 100 for implementing a radiance field may include an input unit 110, a storage unit 120, a control unit 130, and an output unit 140.

The input unit 110 may receive user commands as inputs. To this end, the input unit 110 may be connected to various input devices via a wireless or wired network.

In this case, the input unit 110 may receive user commands for implementing the radiance field, as well as user commands for specifying an arbitrary camera viewpoint for the trained neural radiance field (NeRF) as inputs.

The storage unit 120 may store data and instructions necessary for the operation of the system 100 for implementing a radiance field according to the present invention.

For example, the storage unit 120 may store information related to the neural radiance field (NeRF), as well as information related to the set of scene images and camera viewpoints.

The control unit 130 may control the overall operation of the system 100 for implementing a radiance field according to the present invention.

For example, the control unit 130 may generate a generated image corresponding to the finite space on the basis of the set of scene images and use the generated image to train the neural radiance field (NeRF).

In addition, the control unit 130 may generate a new image from an arbitrary camera viewpoint using the neural radiance field (NeRF).

The output unit 140 may be connected to a display device via a wireless or wired network. Accordingly, the output unit 140 may output information generated by the control unit 130.

For example, the output unit 140 may output the set of scene images and output the new image generated from the neural radiance field (NeRF).

With the configuration of the system 100 for implementing a radiance field as described above, the following will provide a more detailed description of a method of implementing a radiance field.

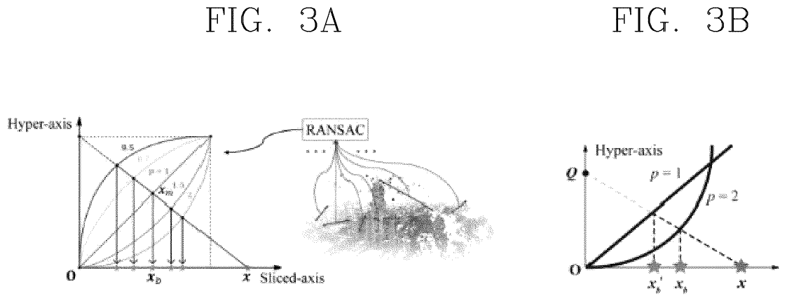

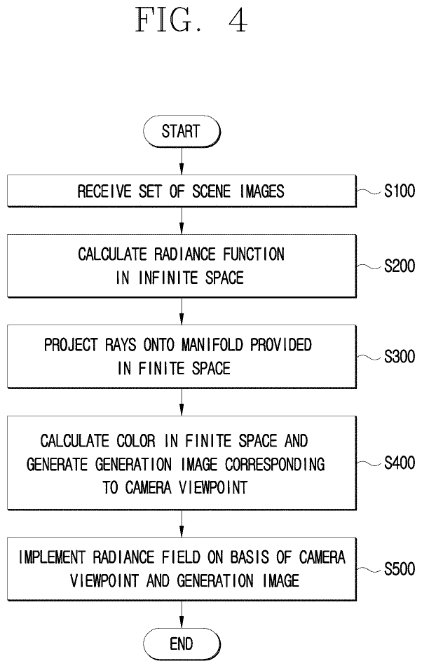

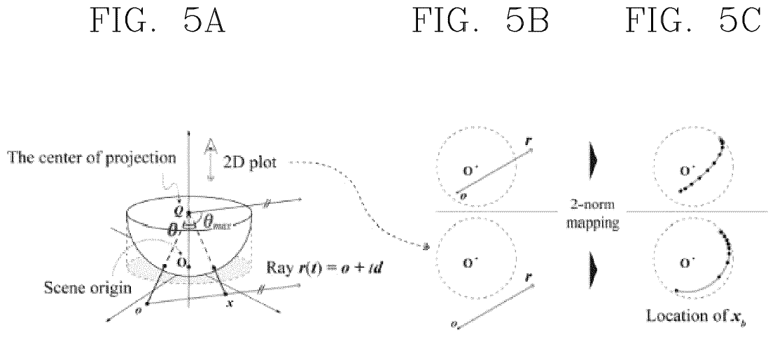

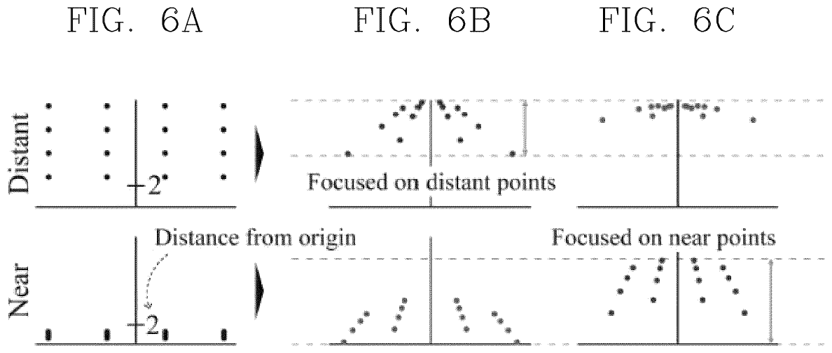

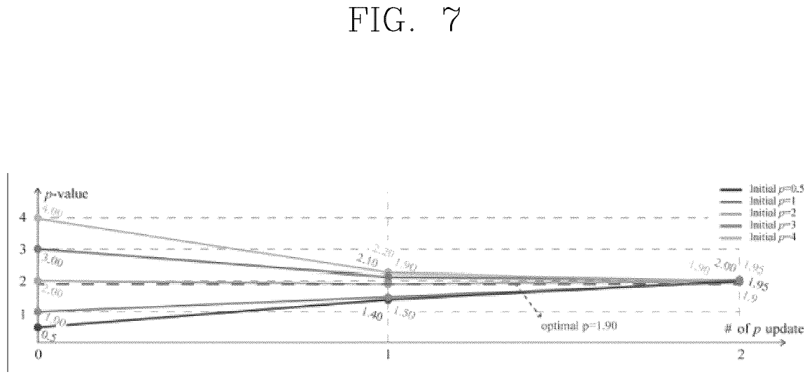

FIG. 4 is a flowchart illustrating a method of implementing a radiance field according to the present invention. FIGS. 5A to 5C illustrate an embodiment of mapping rays from an infinite space to a finite space. FIGS. 6A to 6C illustrate an embodiment of sampling points based on a value of p for the P-Norm distance. FIG. 7 illustrates an embodiment of specifying an optimal value of p for the P-Norm distance.

With reference to FIG. 4, the system 100 for implementing a radiance field according to the present invention may receive the set of scene images (S100) and calculate the radiance function in the infinite space on the basis of the camera viewpoints for the set of scene images (S200).

Specifically, the system 100 for implementing a radiance field may calculate the radiance function according to the position and direction of each camera using the viewpoints of the plurality of cameras corresponding to each of the plurality of images included in the set of scene images.

For example, the system 100 for implementing a radiance field may calculate the radiance function by specifying the position of the camera as a starting point of the ray and specifying the direction of the camera as a direction of the ray.

In an embodiment, the radiance function may be represented as shown in Equation 1 below.

$$r ( t ) = 0 + td \qquad Equation 1$$

Here, r(t) may represent a radiance function, o may be a starting point of the ray, t may be a ray parameter to be described below, and d may represent a direction of the ray.

The system 100 for implementing a radiance field according to the present invention may project the rays based on the radiance function in the infinite space onto a manifold in the finite space using a predefined mapping function based on the P-Norm distance (S300).

Specifically, the system 100 for implementing a radiance field may calculate the central point of the projection on the basis of the positions of the plurality of cameras corresponding to each of the plurality of images included in the set of scene images.

For example, the system 100 for implementing a radiance field may calculate the central point of the plurality of cameras as the central point of the projection, on the basis of the positions of the plurality of cameras corresponding to the set of scene images.

As another example, the system 100 for implementing a radiance field may calculate an average value of the positions of the plurality of cameras and specify the calculated average value as the central point of the projection.

Further, the system 100 for implementing a radiance field may calculate an angle between the starting point of the ray based on the radiance function in the infinite space and an arbitrary point on the corresponding ray, with respect to the previously calculated central point of the projection, and may then calculate a ratio between the calculated angle and a predetermined maximum angle for the corresponding angle as a ray parameter.

With reference to FIG. 5A, for example, the system 100 for implementing a radiance field may calculate an angle between a first line, which connects the central point Q of the projection and the starting point o of the ray according to the radiance function r(t), and a second line, which connects the central point of the projection Q to an arbitrary point x on the radiance function r(t).

In an embodiment, the angle calculated with respect to the central point of the projection may be represented as shown in Equation 2 below.

$$θ = ∠ ( x - Q , o - Q ) \qquad Equation 2$$

Here, θ may be an angle between two points calculated with respect to the central point of the projection, x may be an arbitrary point on the radiance function, and Q may be the central point of the projection.

Meanwhile, the system 100 for implementing a radiance field may calculate a maximum angle for an angle calculated with respect to the central point of the projection using the direction of the ray based on the radiance function.

In an embodiment, the maximum angle may be represented as shown in Equation 3 below.

$${θ}_{max} = ∠ ( d - Q , 0 - Q ) \qquad Equation 3$$

Here, θₘₐₓ may represent a maximum angle, and d may represent the direction of the ray as based on the radiance function (or the direction of the camera).

Accordingly, the system 100 for implementing a radiance field may calculate the ratio between an angle formed by the starting point of the ray and a point on the radiance function, and the maximum angle, thereby acquiring a ray parameter normalized according to the maximum angle.

In an embodiment, the ray parameter may be represented as shown in Equation 4 below.

$$\frac{θ}{{θ}_{max}} \qquad Equation 4$$

Therefore, the system 100 for implementing a radiance field may project the ray, which appears in the infinite space, onto the manifold in the finite space on the basis of the ray parameter.

Specifically, the system 100 for implementing a radiance field may calculate the positions of the plurality of points projected onto the manifold in the finite space from the radiance function in the infinite space, based on the previously calculated ray parameter.

With reference to FIG. 5B and FIG. 5C, for example, the system 100 for implementing a radiance field may specify a plurality of ray parameter values within a predetermined numerical range (e.g., 0 to 1) with a predetermined numerical interval (e.g., 0.1), for the previously calculated ray parameter.

Accordingly, the system 100 for implementing a radiance field may calculate the position of a point on the radiance function (e.g., x in Equation 2) corresponding to each of the previously specified plurality of ray parameter values and specify the calculated positions of the plurality of points as the positions of the plurality of points xb projected onto the manifold in the finite space.

Further, the system 100 for implementing a radiance field may sample the previously calculated plurality of points using a predefined mapping function based on the P-Norm distance.

For example, the system 100 for implementing a radiance field may calculate a P-Norm distance between each of the previously calculated plurality of points and the central point of the projection, according to the predefined mapping function, and may sample a plurality of points to specify a plurality of sampling points on the basis of the calculated P-Norm distance.

In an embodiment, the predefined mapping function based on the P-Norm distance may be represented as shown in Equation 5 below.

$${X}_{m} = \{ {x}_{m} \vert {‖ {x}_{m} - Q ‖}_{p} = 1 and ( {x}_{m} - Q ) \cdot Q < 0 \} \qquad Equation 5$$

Here, Xₘ may represent the positions of a plurality of sampling points, xₘ may represent the positions of the plurality of points previously calculated on the basis of the ray parameter, and ∥∥ₚ may represent a P-Norm distance.

Therefore, the system 100 for implementing a radiance field may specify a point as a sampling point among the previously calculated plurality of points when the P-Norm distance between each point and the central point of the projection corresponds to a predetermined first reference value (e.g., 1), and a difference between the position of each point and the central point of the projection is smaller than a predetermined second reference value (e.g., 0).

As another example, the system 100 for implementing a radiance field may specify an arbitrary first value of p for the predefined mapping function, and specify a plurality of first sampling points through the mapping function based on the specified first value of p.

Accordingly, the system 100 for implementing a radiance field may identify a first distribution of the previously specified plurality of first sampling points on the manifold in the finite space.

In addition, the system 100 for implementing a radiance field may specify an arbitrary second value of p different from the previously specified first value of p, and specify a plurality of second sampling points through the mapping function based on the specified second value of p. The system may then identify a second distribution of the previously specified plurality of second sampling points on the manifold in the finite space.

As described above, the system 100 for implementing a radiance field may specify the sampling points on the manifold in the finite space on the basis of different values of p. In this case, the system may specify the value of p that results in the broadest distribution of sampling points on the manifold, and then specify the plurality of sampling points according to the corresponding value of p.

Therefore, the system 100 for implementing a radiance field may specify a final value of p as a maximum distance that utilizes the full capacity of an embedding space (e.g., finite space).

In this regard, with reference to FIGS. 6A to 6C, it can be seen that a plurality of points a, specified based on the radiance function appearing in a straight-line form in the infinite space, are mapped and sampled onto the finite space through the mapping function, resulting in a plurality of sampling points b and c.

In this case, FIG. 6B illustrates a plurality of sampling points that were sampled based on the P-Norm distance of a relatively small value of p (e.g., p=1), and it can be seen that the plurality of sampling points are disposed even in the distant region.

In addition, FIG. 6C illustrates a plurality of sampling points that were sampled based on the P-Norm distance of a relatively large value of p (e.g., p=2), and it can be seen that the plurality of sampling points are focused and disposed in the near region.

With reference back to FIG. 4, the system 100 for implementing a radiance field according to the present invention may calculate the color (and density) in the finite space corresponding to the set of scene images on the basis of the projected rays, generate a generated image corresponding to the camera viewpoint on the basis of the calculated color (S400), and implement the radiance field on the basis of the camera viewpoint and the generated image (S500).

Specifically, the system 100 for implementing a radiance field may calculate the color in the finite space on the basis of the set of scene images and the plurality of sampling points sampled for the rays projected onto the manifold in the finite space.

For example, the system 100 for implementing a radiance field may calculate the color in the finite space corresponding to a camera viewpoint using the color and density of each of the plurality of images included in the set of scene images, as well as the plurality of sampling points calculated on the basis of the viewpoint of the corresponding camera.

In an embodiment, the color in the finite space may be represented as shown in Equation 6 below.

$$C ( r ) = {\sum }_{i = 1}^{N} {T}_{i} ( 1 - exp ( - {σ}_{i} {δ}_{i} ) ) {c}_{i} , s . t . {T}_{i} = exp ( - {\sum }_{j = 1}^{i - 1} {σ}_{j} {δ}_{j} ) \qquad Equation 6$$

Here, C(r) may represent a color corresponding to a camera viewpoint in the finite space, σ may represent the density (or opacity) of each of a plurality of images included in the set of scene images, δ may represent a distance between two adjacent sampling points, c may represent a color of each of the plurality of images included in the set of scene images, and N may represent the number of a plurality of sampling points.

Further, the system 100 for implementing a radiance field may generate a generated image corresponding to the camera viewpoint for each of the plurality of images included in the set of scene images using the previously calculated color in the finite space.

For example, the system 100 for implementing a radiance field may calculate the color in the finite space based on the camera viewpoint corresponding to each image for each of the plurality of pixels belonging to each image in the set of scene images. The system may then dispose the previously calculated color to correspond to the plurality of pixels to generate a generated image corresponding to the camera viewpoint.

In this case, the system 100 for implementing a radiance field may calculate an error by comparing the trained radiance field (or radiance field implemented based on the generated image) with the distances of pre-obtained point samples. On the basis of the calculated error, the system may then specify an optimal value of p for the P-Norm distance.

Here, the pre-obtained point samples may include a plurality of points arbitrarily specified from the point cloud of the set of scene images.

To this end, the system 100 for implementing a radiance field may generate a radiance field from the set of scene images using a predetermined initial value of p, and calculate a first error using the points sampled from the generated radiance field.

Subsequently, the system 100 for implementing a radiance field may specify a first value of p different from the initial value of p, and generate a radiance field from the set of scene images using the specified first value of p. The system may then calculate a second error for the points sampled from the generated radiance field.

Accordingly, the system 100 for implementing a radiance field may specify a second value of p in consideration of at least of the initial value of p or the first value of p, on the basis of a difference (or rate of increasing or decreasing) between the previously calculated first error and second error.

Subsequently, the system 100 for implementing a radiance field may repeat the process of adjusting the value of p until the error between the set of scene images and the generated image satisfies a predetermined condition and generating a generated image from the set of scene images on the basis of the adjusted value of p to calculate an error.

In this case, the predetermined condition for the error between the set of scene images and the generated image may be set to various conditions, such as a predetermined value (e.g., 0.04), or the number of iterations.

Therefore, the system 100 for implementing a radiance field may generate a generated image from the set of scene images using an optimal value of p that satisfies the predetermined condition for the error.

In this regard, with reference to FIG. 7, it can be seen that the graph shows that a generated image is generated from the set of scene images and an optimal value of p is specified on the basis of the error between the set of scene images and the generated image.

Further, the system 100 for implementing a radiance field may, when a specific camera viewpoint is provided as input, train the neural radiance field (NeRF) so that an image corresponding to the input specific camera viewpoint is generated. In this case, the neural radiance field (NeRF) may be trained such that the loss between the image generated from the neural radiance field (NeRF) and the generated image previously generated according to the specific camera viewpoint is minimized.

Therefore, the system 100 for implementing a radiance field can use the neural radiance field (NeRF) to generate an image corresponding to an arbitrary camera viewpoint.

That is, the system 100 for implementing a radiance field may input an arbitrary camera viewpoint into the neural radiance field (NeRF) that has been trained to acquire an image corresponding to the input camera viewpoint.

With the configurations as described above, the system 100 for implementing a radiance field according to the present invention can adaptively sample the camera rays for both scenes with boundaries and scenes without boundaries in the image by projecting the camera rays onto the manifold in the finite space through a mapping function defined based on the P-Norm distance.

In addition, the system 100 for implementing a radiance field according to the present invention can accurately estimate an image from other camera viewpoints even for images of boundary-free scenes, including backgrounds, by training the neural radiance field (NeRF) on the basis of the rays of the camera projected onto the manifold in the finite space.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of implementing a radiance field, comprising:
receiving a set of scene images;
calculating a radiance function in an infinite space on the basis of camera viewpoints for the set of scene images;
projecting rays based on the radiance function in the infinite space onto a manifold in a finite space using a predefined mapping function based on a P-Norm distance;
calculating a color in the finite space corresponding to the set of scene images on the basis of the projected rays and generating a generated image corresponding to the camera viewpoints on the basis of the calculated color; and
implementing a radiance field on the basis of the camera viewpoints and the generated image.

2. The method of claim 1, wherein, in the projecting of rays onto the manifold, a ray, which appears in a straight-line form in the infinite space, is projected to convert the ray in a straight-line form into a ray in a curved form.

3. The method of claim 1, wherein the finite space is a space in which the manifold having a central point of projection is formed.

4. The method of claim 3, wherein the central point of projection is calculated on the basis of positions of a plurality of cameras corresponding to the set of scene images.

5. The method of claim 3, wherein the projecting of rays onto the manifold includes:
calculating an angle between a starting point of the ray based on the radiance function in the infinite space and an arbitrary point on the ray, with respect to the central point of projection;
calculating a ratio between the calculated angle and an maximum angle predetermined for the angle as a ray parameter; and
projecting the ray appearing in the infinite space onto the manifold in the finite space on the basis of the ray parameter.

6. The method of claim 5, wherein the projecting of the ray onto the manifold in the finite space includes:
calculating positions of a plurality of points projected onto the manifold in the finite space from the radiance function in the infinite space on the basis of the ray parameter; and
sampling the calculated plurality of points using a predefined mapping function based on the P-Norm distance.

7. The method of claim 1, wherein the implementing of the radiance field includes:
comparing the implemented radiance field with pre-obtained point samples to calculate an error; and
specifying a value of p for the P-Norm distance on the basis of the calculated error.

8. The method of claim 7, wherein the specifying of the value of p includes:
specifying a second value of p on the basis of a difference between a first error calculated on the basis of a predetermined initial value of p and a second error calculated on the basis of a first value of p, which is different from the initial value of p; and
repeating a process of adjusting the value of p until an error between the set of scene images and the generated image satisfies a predetermined condition and generating the generated image from the set of scene images on the basis of the adjusted value of p to calculate an error.

9. A system for implementing a radiance field, comprising:
an input unit configured to receive a set of scene images; and
a control unit configured to implement a radiance field on the basis of the set of scene images,
wherein control unit is configured to:
calculate a radiance function in an infinite space on the basis of camera viewpoints for the set of scene images,
project rays based on the radiance function in the infinite space onto a manifold in a finite space using a predefined mapping function based on a P-Norm distance,
calculate a color in the finite space corresponding to the set of scene images on the basis of the projected rays,
generate a generated image corresponding to the camera viewpoints on the basis of the calculated color, and
implement a radiance field on the basis of the camera viewpoints and the generated image.

10. A program stored on a computer-readable recording medium, and executed by one or more processes in an electronic device, the program comprising instructions to allow the program to perform:
receiving a set of scene images;
calculating a radiance function in an infinite space on the basis of camera viewpoints for the set of scene images;
projecting rays based on the radiance function in the infinite space onto a manifold in a finite space using a predefined mapping function based on a P-Norm distance;
calculating a color in the finite space corresponding to the set of scene images on the basis of the projected rays and generating a generated image corresponding to the camera viewpoints on the basis of the calculated color; and
implementing a radiance field on the basis of the camera viewpoints and the generated image.
